(19) United States
(12) Patent Application Publication
(10) Pub. No.: US 2012/0240451 A1
(43) Pub. Date: Sep. 27, 2012

(54) System and Method for Killing Bed Bugs and Other Insects

(76) Inventor: Gary C. Ricks, Logan, UT (US)

(21) Appl. No.: 13/424,196

(22) Filed: Mar. 19, 2012

Related U.S. Application Data
(60) Provisional application No. 61/454,932, filed on Mar. 21, 2011.

(51) Int. Cl. A01M 13/00; A01M 1/00

(52) U.S. Cl. 43/130; 43/132.1

(57) ABSTRACT

Systems and methods for killing bed bugs and other insects utilizing steam to increase the temperature of an area beyond the bed bugs' and other insect's thermal death point. Steam created by a steam generator is directed into an area for a sufficient amount of time to ensure that the bed bugs and other insects die. Furthermore, the systems and methods may include a barrier that defines a thermal kill zone which prevents bed bugs and other insects from escaping during treatment. Injection members may be used to more precisely direct steam in specific areas within the thermal kill zone and/or in joints, cracks, or crevices where bed bugs and other insects may be located.

### RELATED APPLICATIONS

The present application claims the benefit of U.S. Provisional Application Ser. No. 61/454,932, filed Mar. 21, 2011, which is expressly incorporated herein in its entirety.

### THE FIELD OF THE INVENTION

The present invention generally relates to a system and methods for killing bed bugs and other insects. More specifically, the present invention relates to a steam injection system and method that is used to expose bed bugs and other insects to temperatures sufficiently high enough to kill the bed bugs and other insects.

### BACKGROUND

Bed bugs have been known human parasites for thousands of years. Bed bugs are small, oval, non-flying insects that belong to the insect family Cimicidae. There are over one hundred species in this family. However, two species live almost exclusively on humans—Cimex lectularius, found primarily in temperate areas, and Cimex hemipterus, which is mostly found in tropical areas.

The name “bed bug” is derived from the insect's preferred habitat of houses and especially beds or other areas where people sleep. More recently, there has been focus on the discovery of bed bugs in upscale hotels. Bed bugs, though not strictly nocturnal, are mainly active at night and are capable of feeding unnoticed on their hosts. Bed bugs can live in any area of the home and can reside in tiny cracks in furniture as well as on textiles and upholstered furniture. They do not infest the sleeping surfaces of beds as commonly as cracks and crevices associated with the bed frame, box spring, and mattress. Other sites where bed bugs often reside include curtains, edges of carpet, corners inside dressers and other furniture, cracks in wallpaper (particularly near the bed), and inside the spaces of wicker furniture, to name a few.

Bed bugs are obligatory hematophagous (bloodsucking) insects. Most species feed on humans only when other prey is unavailable. The behavior of the bed bug can be described as feed and hide. They feed quickly, usually less than about ten minutes, and then hide close to the host for a week or two before feeding again. Bed bugs are attracted to their hosts primarily by carbon dioxide, secondarily by warmth, and also by certain chemicals. A bed bug pierces the skin of its host with two hollow feeding tubes shaped like tongues. With one tube it injects its saliva, which contains anticoagulants and anesthetics, while with the other it withdraws the blood of its host. After feeding for about five minutes to ten minutes, the bug returns to its hiding place. Although bed bugs can live for a year without feeding they normally try to feed every five to ten days. In cold weather, bed bugs can live for about a year; at temperatures more conducive to activity and feeding bed bugs live for about five months.

A number of adverse health effects may occur in humans due to having a bed bug infestation, including skin rashes, psychological effects and allergic symptoms. Bed bug bites may lead to a range of skin manifestations from no visible effects to prominent blisters. Diagnosis involves both finding the bed bugs and the occurrence of compatible symptoms. Attending to the symptoms of a bed bug infestation is the primary short term treatment for these adverse health effects. The only method for treating a patient long term is to eliminate the insect from the patient's habitation.

Although bed bugs were largely eradicated as pests in the early 1940s in the developed world, more recently, the prevalence of bed bugs is again on the increase. The exact causes of this resurgence remain unclear; it is variously ascribed to greater foreign travel, more frequent exchange of second-hand furnishings among homes, a greater focus on control of other pests resulting in neglect of bed bug countermeasures, and increasing resistance to pesticides.

Dwellings can become infested with bed bugs in a variety of ways. Bugs and eggs can be carrying into the dwelling on pets, infested items (such as furniture, luggage or clothing) brought into the dwelling, through duct work or false ceilings, by wild animals such as bats or birds, or from other sources. Bed bugs live in any articles of furniture, clothing, or bedding, so they or their eggs may be present in used furniture or clothing. They spread by crawling and may contaminate multiple rooms in a home or even multiple dwellings in apartment buildings. Bed bugs can be found singly, but often congregate once established. They usually remain close to hosts, commonly in or near beds or couches. The eggs of bed bugs are found in similar places where the bed bugs themselves are found, and are attached to surfaces by a sticky substance.

Getting rid of bed bugs is not an easy process, and most cases of bed bug infestation will require treatment by a pest-control expert. A variety of low-odor sprays, dusts, and aerosol insecticides have been used to eradicate bed bugs. These must be applied to all areas where the bugs are observed as well as spaces where they may crawl or hide. However, because beds and other furniture cannot readily be treated completely with insecticides, it is often necessary to discard the infested mattresses and furniture.

Pesticides that have historically been found to be effective include: pyrethroids, dichlorvos and malathion. However, the use of pesticides raises concerns of negative health effects as a result of pesticide use. For example the carbamate insecticide propoxur is highly toxic to bed bugs, but in the United States the Environmental Protection Agency (EPA) has been reluctant to approve such an indoor use of propoxur because of its potential toxicity to children after chronic exposure.

Moreover, bed bug resistance to pesticides appears to be increasing dramatically. Bed bugs are developing resistance to various pesticides including DDT and organophosphates. Bed bug populations sampled across the U.S. showed a tolerance for pyrethroids several thousands of times greater than laboratory bed bugs. New York City bed bugs have been found to be 264 times more resistant to deltamethrin than Florida bed bugs due to nerve cell mutations.

Thermal remediation has been used as an alternative to pesticide treatment of bed bugs. The three most important keys of success in thermal remediation treatment is the heat, movement of the heat, and monitoring of the heat. The thermal death point for C. lectularius is high, 45° C. or 113° F., and all stages of life may be killed by seven minutes of exposure to 46° C. or 115° F. Thus, the idea of the thermal remediation treatment is to eliminate the bed bugs through prolonged exposure of excess amount of heat ranging in temperatures of 120° and higher.

Although thermal remediation systems for the eradication of insects have been previously suggested by the prior art, these systems typically use a heating element that gradually raises the temperature of the room above the thermal death point of the bed bugs. Bed bugs and other insects, however, may react to the gradual temperature increase by escaping to a different room in the habitation or by hiding in places insulated from the increased temperature such as a deep crack or crevice or inside of walls, etc. Thus, once the treatment of the room is completed, the bed bugs or other insects may return.

Thus, there is a need for an improved system and method for killing bed bugs and other insects.

### SUMMARY OF THE INVENTION

It is an object of the present invention to provide an improved system and method for killing bed bugs and other insects.

According to one aspect of the present invention, a steam injection system for killing bed bugs and other insects may include a steam generator, wherein the steam generated by the steam generator may be directed to an area being treated for a period of time in order to raise the temperature of the area above the thermal kill temperature of bed bugs and other insects.

According to another aspect of the present invention, a steam injection system for killing bed bugs and other insects may include a barrier that creates a thermal kill zone which may prevent bed bugs and other insects from escaping from the area being treated.

According to another aspect of the present invention, the barrier of the steam injection system may be comprised of a conduit having a high temperature fluid therein which increase the temperature of the conduit to a sufficient degree to prevent bed bugs and other insects from leaving the area being treated.

According to another aspect of the present invention, a steam injection system for killing bed bugs and other insects may include an injection member operably connected to the steam generator for directing the steam more precisely in a given area.

According to another aspect of the present invention, an injection member may be operably connected to a steam injection system via an injection manifold.

According to another aspect of the present invention, a steam injection system for killing bed bugs and other insects may include a plurality of injection members.

According to yet another aspect of the present invention, the steam may be directed into an area being treated at temperatures of up to about 212° Fahrenheit and at pressure of about 5 pounds per square inch or less.

According to still another aspect of the present invention, the injection manifold may include a drain valve to allow condensate to exit the steam injection system.

According to another aspect of the present invention, a steam injection system for killing bed bugs and other insects may include a cover for placing on an area to substantially contain the steam in the area being treated.

According to still another aspect of the present invention, a method for injecting steam into an area to kill bed bugs and other insects may include selecting a steam generator and directing steam created by the steam generator into an area surrounded by a barrier defining a thermal kill zone. Injection members may be connected to the steam generator to direct the steam into the area being treated more precisely. For example, injection members may be inserted between the box spring and mattress of a bed and the bed may have a cover thereon to contain the steam being injected.

According to another aspect of the present invention, a method for killing bed bugs and other insects may include using a barrier to create a thermal kill zone, which may include a bed and bed frame or other furniture. Steam may be injected into the thermal kill zone to rapidly raise the temperature above the thermal death point of the bed bugs or other insects trapped inside the thermal kill zone for an extended period of time. The method may also include using an injection member to direct steam into cracks and crevices of the bed and bed frame or other furniture, and to direct steam into the carpet or other surfaces within the thermal kill zone.

In accordance with one aspect of the present invention, a method for killing bed bugs and other insects may include treating a habitation by setting up a first thermal kill zone to eradicate the bed bugs and other insects located within the first thermal kill zone. Thereafter, setting up a second thermal kill zone in a different location to eradicate the bed bugs and other insects located within the second thermal kill zone. Then continuing on to different locations setting up a third thermal kill zone and any necessary subsequent thermal kill zones to ensure the habitation is completely eradicated of bed bugs and other insects.

In accordance with still another aspect of the present invention, a method for killing bed bugs and other insects may include manually treating areas in a habitation using an injection member to direct steam in order to kill the bed bugs and other insects.

According to another aspect of the present invention, a method for killing bed bugs and other insects may include setting up a plurality of thermal kill zones at various locations in a habitation to kill bed bugs and other insects located within the plurality of thermal kill zones simultaneously.

These and other aspects of the present invention are realized in a steam injection system and method that is used to expose bed bugs and other insects to temperatures sufficiently high enough to kill the bed bugs and other insects as is shown and described in the following figures and related description.

### BRIEF DESCRIPTION OF THE DRAWINGS

Various embodiments of the present invention are shown and described in reference to the numbered drawings wherein:

FIG. 1 shows a top view of a steam injection system according to principles of the present invention;

FIG. 2 shows a perspective view of a steam injection system of the present invention;

FIG. 3 shows a side view of a bed being treated to eradicate bed bugs and other insects according to principles of the present invention;

FIG. 4 shows an injection member of the steam injection system of the present invention;

FIG. 5 shows an injection member of the steam injection system of the present invention;

FIG. 6 shows another injection member of the steam injection system of the present invention;

FIG. 7 shows yet another injection member of the steam injection system of the present invention;

FIG. 8 shows a side view of a steam injection system according to principles of the present invention; and

FIG. 9 shows a perspective view of a multi zone steam injection system according to principles of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

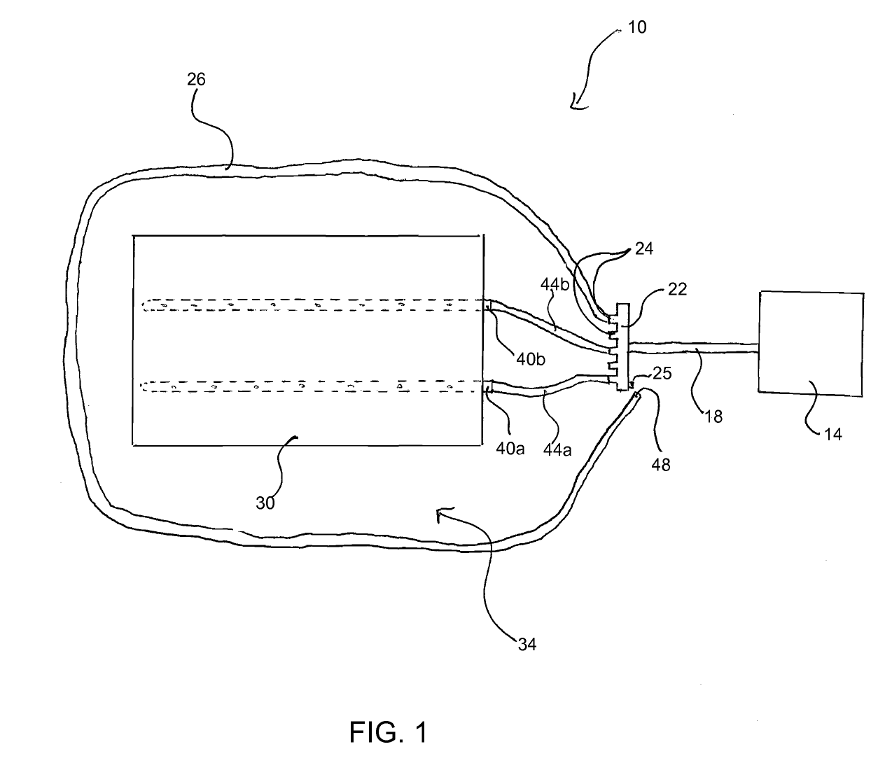

Turning now to FIG. 1, a top view of a steam injection system, generally indicated at 10, according to principles of the present invention is shown. The steam injection system may include a steam generator 14. The steam generator may be, for example a Lattner Boiler System, Model H.E. tubeless boiler, or other available device which will produce adequate steam. The steam generator 14 can supply steam to the steam injection system 10 at temperature of about 212° F. and deliver the steam to the system 10 at pressures of about 5 PSI or less. One skilled in the art, however, will appreciate that steam generator 14 may supply steam to the steam injection system 10 at temperatures that exceed 212° F. at pressures above 5 PSI.

Although thermal remediation has been suggested for treating bed bug and other insect eradication, typically these systems use dry heat to gradually raise the temperature of a room or other volume of space being treated. This can take an hour or more to get the temperature above the lethal limit for bed bugs. However, treating an area by gradually raising the temperature may allow bed bugs and other insects to escape the area being treated by relocating to a different area that is insulated from high temperatures, such as an adjacent room, or a deep crack or crevice, or an insulated wall. Thus, traditional thermal remediation for the treatment of bed bugs and other insects provides an opportunity for the surviving bed bugs and other insects to reestablish themselves after treatment is complete.

The steam injection system 10 of the present invention, however, is able to heat an area or “kill zone” more rapidly. As water conducts heat better than air, likewise, moist air also conducts heat better than dry air. Thus, the steam injection system 10 minimizes the amount of time for killing the bed bugs or other insects in an area thereby making it less likely that the bed bugs or other insects will escape. Moreover, because the steam injection system 10 of the present invention may heat a specific area more rapidly than conventional thermal remediation systems, the amount of time to treat a habitation may be reduced.

The steam injection system 10 may include a main line 18 connected to the steam generator 14, which directs steam to an injection manifold 22. The injection manifold 22 may include a plurality of ports 24 to which one or more injection members, such as injection members 40a and 40b, may be connected. Injection manifold 22 may also include a valve 25 that allows condensate to drain from the system. To facilitate flow of condensate from the system through the valve, injection manifold 22 may be elevated at an end opposite the valve.

To ensure that no bed bugs or other insects escape during treatment, a barrier 26 may be used to create a thermal kill zone 34. Barrier 26 may be connected to injection manifold 22 and be comprised of a conduit having a high temperature fluid therein, such as steam generated by the steam generator 14 or condensate from the manifold 22 which will remain well above the thermal kill temperature of the bed bugs. The high temperature fluid increases the temperature of the exterior surface of the barrier 26 to a sufficient degree to prevent bed bugs and other insects from moving beyond the barrier 26. Barrier 26 may also include a drain 48 that allows condensate to exit barrier 26.

The steam injection system 10 may also include one or more injection members, such as injection members 40a and 40b. Injection members 40a and 40b may be inserted into a bed 30 or other furniture in order to increase the temperature of the bed 30 or other furniture above the thermal death point of the bed bugs or other insects. For example, it is known that all stages of life of a bed bug may be killed by exposing the bed bug to a temperature of at least 115° F. for seven minutes. Thus injection members 40a and 40b may be used to increase the temperature of the bed 30 or other furniture to a temperature of 115° F. and maintain that temperature for at least seven minutes in order to eradicate all stages of life of bed bugs from bed 30 or other furniture. A temperature probe may used to monitor the temperature to ensure that it stays above the thermal death point of bed bugs and/or other insects for a sufficient amount of time to ensure that all bed bugs and/or other insects die.

It will be appreciated that injection members 40a and 40b may be used to increase the temperature of the bed 30 or other furniture above 115° F. in order to kill insects which have a higher thermal death point and/or killing the bed bugs more quickly than simply heating the ambient air in the room. For example, the temperature of the bed 30 or other furniture can be increase to temperatures that exceed 140° F. Furthermore, a cover (not shown) may be placed on top of the bed 30 or other furniture to better contain the heat therein.

While bed 30 or other furniture inside thermal kill zone 34 is being treated (or after bed 30 or other furniture has been treated for a sufficient period of time to kill bed bugs or other insects located in bed 30), steam may be manually directed into the joints of the bed frame, or other cracks or crevices. Likewise, steam may be manually directed into any carpet or other surfaces to ensure that all bed bugs or other insects located within thermal kill zone 34 have been killed. After completing the treatment of thermal kill zone 34, a second thermal kill zone (and subsequent thermal kill zones) may be set up in a different location within the habitation to thereby totally eradicate all bed bugs or other insects from the dwelling.

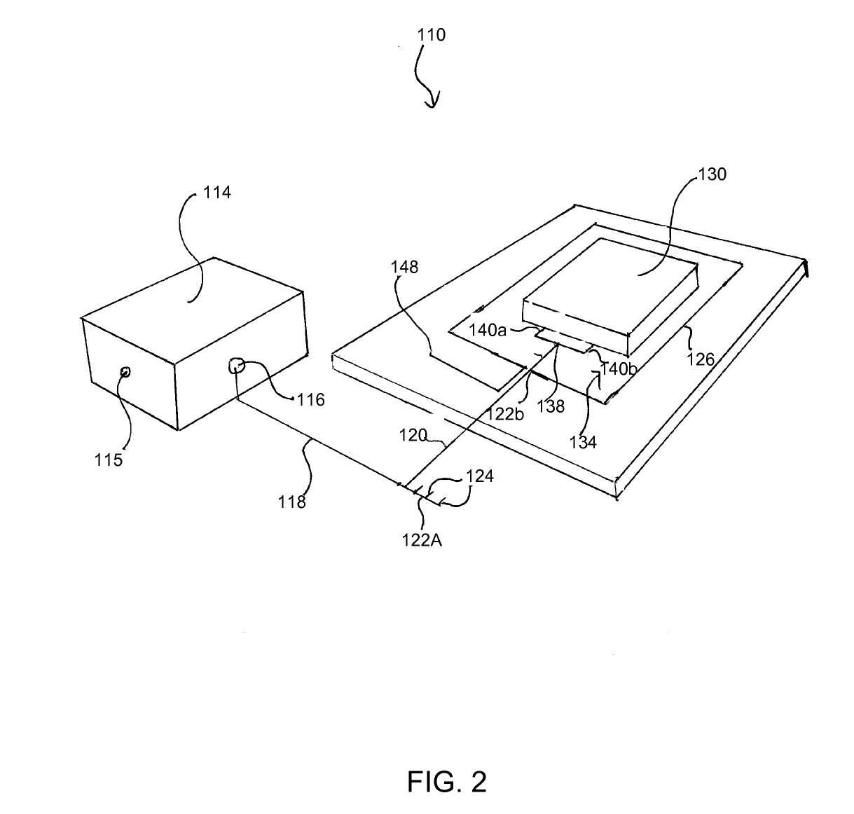

Turning now to FIG. 2, there is shown a perspective view of another steam injection system of the present invention, which is generally indicated at 110. Like FIG. 1, FIG. 2 shows an example of a single thermal kill zone system. Steam injection system may include a plurality of injection manifolds, such as manifolds 122a and 122b. Injection manifold 122a may be connected to steam generator 114 via main line 118. A primary line 120 may be connected at a first end to a port 124 of manifold 122a to direct steam to thermal kill zone 134. (As discussed in further detail below, the additional ports 124 on injection manifold 122a may be utilized to set up additional thermal kill zones at different locations in a habitation.) At a second end, primary line 120 may be connected to injection manifold 122b.

Like injection manifold 122a, injection manifold 122b may include a plurality of ports. Attached to the ports may be one or more injection members, such as injection members 140a and 140b, and a barrier line 126. As is shown in FIG. 2, steam may be directed to injection members 140a and 140b from injection manifold 122b via a single line 136 that tees off at 138 to the separate injection members 140a and 140b. Treatment of thermal kill zone 134 proceeds similarly to the manner described above in connection with FIG. 1.

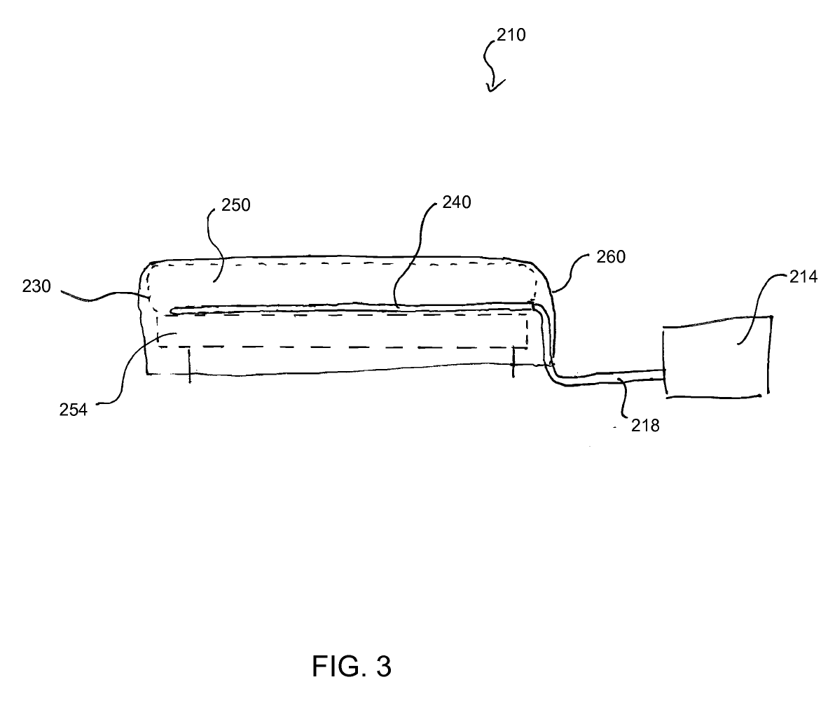

Turning to FIG. 3, there is shown a side view of a steam injection system, generally indicated at 210, to treat a bed for bed bugs or other insects according to principles of the present invention. The steam injection system 210 may include one or more injection members 240 inserted in between the mattress 250 and box string 254 of bed 230. The steam injection system 210 may also include a cover 260. Cover 260 may be comprised of multiple layers, for example, cover 260 may comprise a tarp placed on top of bed 230 with a blanket covering the tarp. Cover 260 helps contain the heat within bed 230 to increase the efficiency of killing bed bugs or other insects by steam injection system 210.

It will be appreciated that the various aspects of the steam injection systems discussed herein may be the same. For example, steam generator 14 may be the same as steam generators 114 and 214. Likewise, injection manifold 22 may be the same as injection manifold 122a. Different reference numerals may have been used to describe similar structures in the various steam injection systems for clarity purposes only.

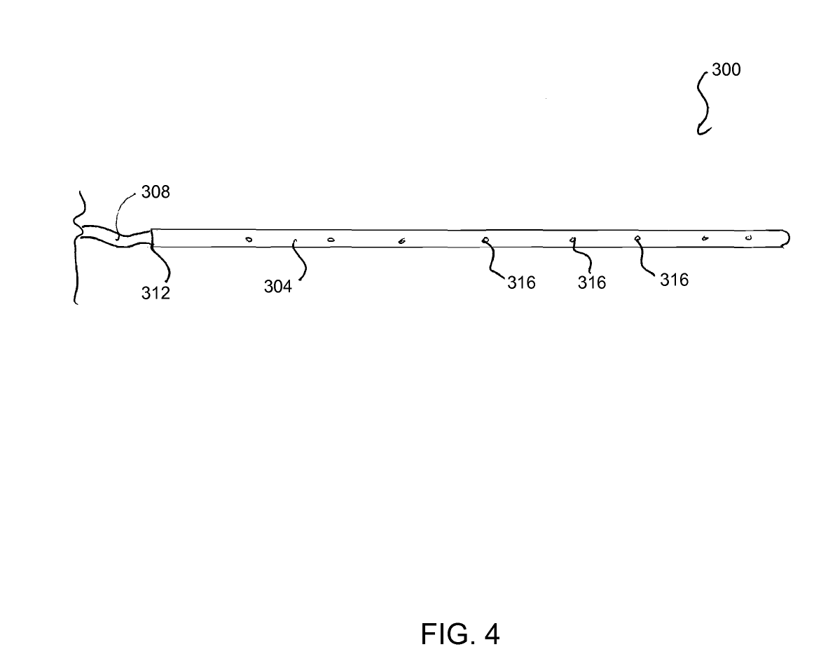

Referring now to FIGS. 4 through 7 which show fragmented views of various injection members that may be used with the steam injection systems described herein. FIG. 4 shows an injection member, generally indicated at 300, having an elongated body 304. Injection member 300 may be inserted into large furniture, such as beds or couches, in order to more precisely direct steam therein. The elongate body 304 may include a plurality of holes 316 which allow the steam to escape from the body 304 and penetrate the furniture. Injection member 300 may be connected to a line 308 at one end 312 that provides steam created by a steam generator (not shown).

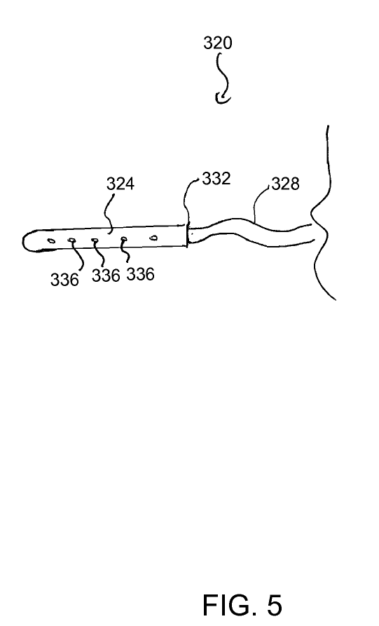

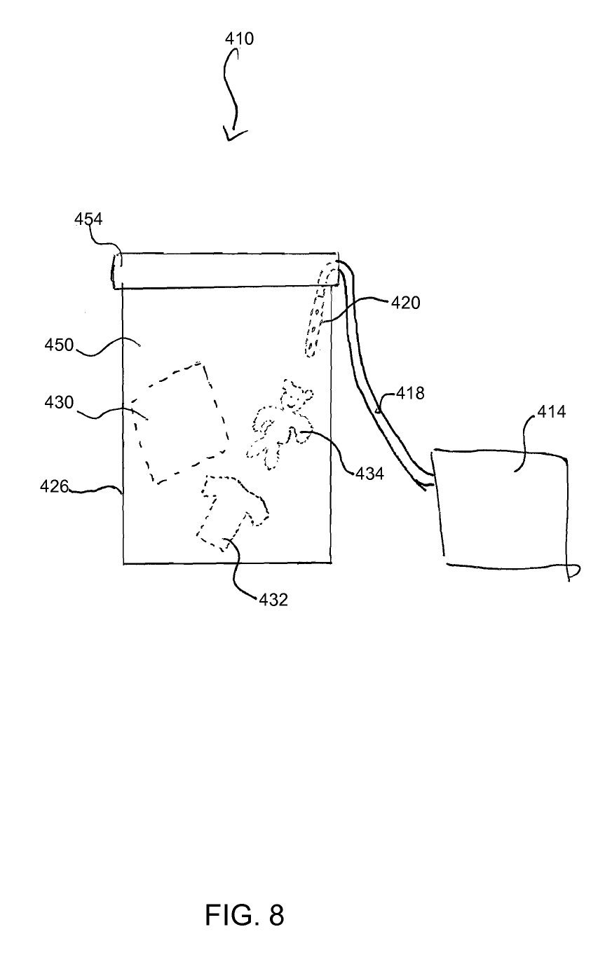

FIG. 5 shows another injection member, generally indicated at 320. Injection member 320 may have a body 324 that is shorter in length relative to injection member 300 (FIG. 4). Injection member 320 may be utilized for injecting steam into a thermal kill zone that is more compact. For example, injection member 320 may be used to provide steam to a thermal kill zone comprising a box, such as is shown in FIG. 8.

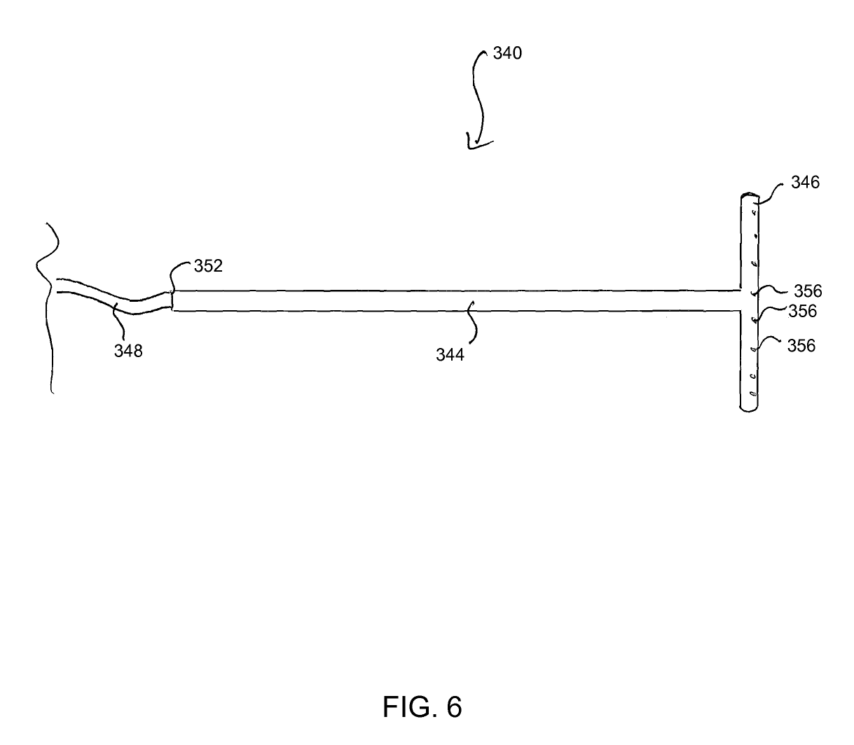

FIG. 6 shows still another injection member, generally indicated at 340. Injection member 340 may have a body 344 that is generally T shaped and include a plurality of holes 356 located at end 346 of body 344. Injection member 340 may be used to manually direct steam into an area. For example injection member 340 may be used to manually direct steam into flooring materials such as carpets, rugs and other flooring, and to areas in a habitation where carpet meets the wall. In order to ensure that any bed bugs or other insects are killed when manually directing steam to an area, the area should be covered at about 1 inch per second.

In practical use, the injection member 340 could be used on the flooring between the barrier 26 and the bed 30 in FIG. 1. Bed bugs and other insects will often try to evacuate the area being treated with heat. Thus, for example, they may drop from the bed 30 and try and run for a wall. The heated barrier 26 keeps them from leaving the kill zone. However, it may take a while for ambient room temperature to kill them. However, by passing the injection member 340 over the flooring around the bed 30, the steam from the injection member will ensure that all of the insects in the kill zone have been killed.

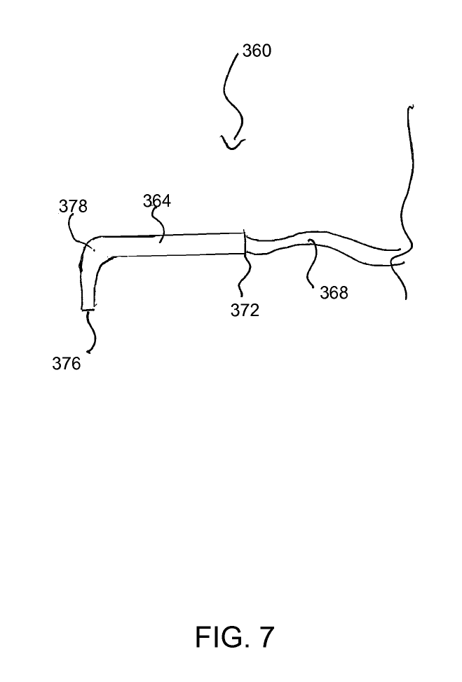

FIG. 7 shows still another injection member, generally indicated at 360. Injection member 360 may have a single opening 376 for steam to exit. Injection member 360 may be used to manually direct steam into joints, cracks, or crevices where bed bugs or other insects may have survived during treatment of a thermal kill zone. Additionally, the body 364 of injection member 360 may be curved at one end, as is shown at 378, in order to better direct steam away from the user of the steam injection system of the present invention. This may be used, for example on a crack in a wall. The steam is injected into the crack to kill bed bugs hiding in the wall to the extent possible and then the crack is sealed to ensure that the bed bugs are not able to return.

Now turning to FIG. 8, there is shown a side view of a steam injection system, generally indicated at 410, according to principles of the present invention. Steam injection system 410 may include a barrier 426 comprised of a box 450 and lid 454. Household items that may provide a place for bed bugs and other insects to live, such as pillows 430, clothing 432, stuffed animals 434, etc., may be placed inside barrier 426 along with an injection member 420. Steam is injected into barrier 426 in order to raise the temperature of the household items contained within barrier 426 above the thermal death point of bed bugs and/or other insects. A temperature monitor may also be placed inside barrier 426 to ensure that the temperature inside barrier 426 is above the thermal death point of bed bugs and/or other insects, and that the temperature remains above the thermal death point for a sufficient amount of time to ensure that all bed bugs and/or other insects die.

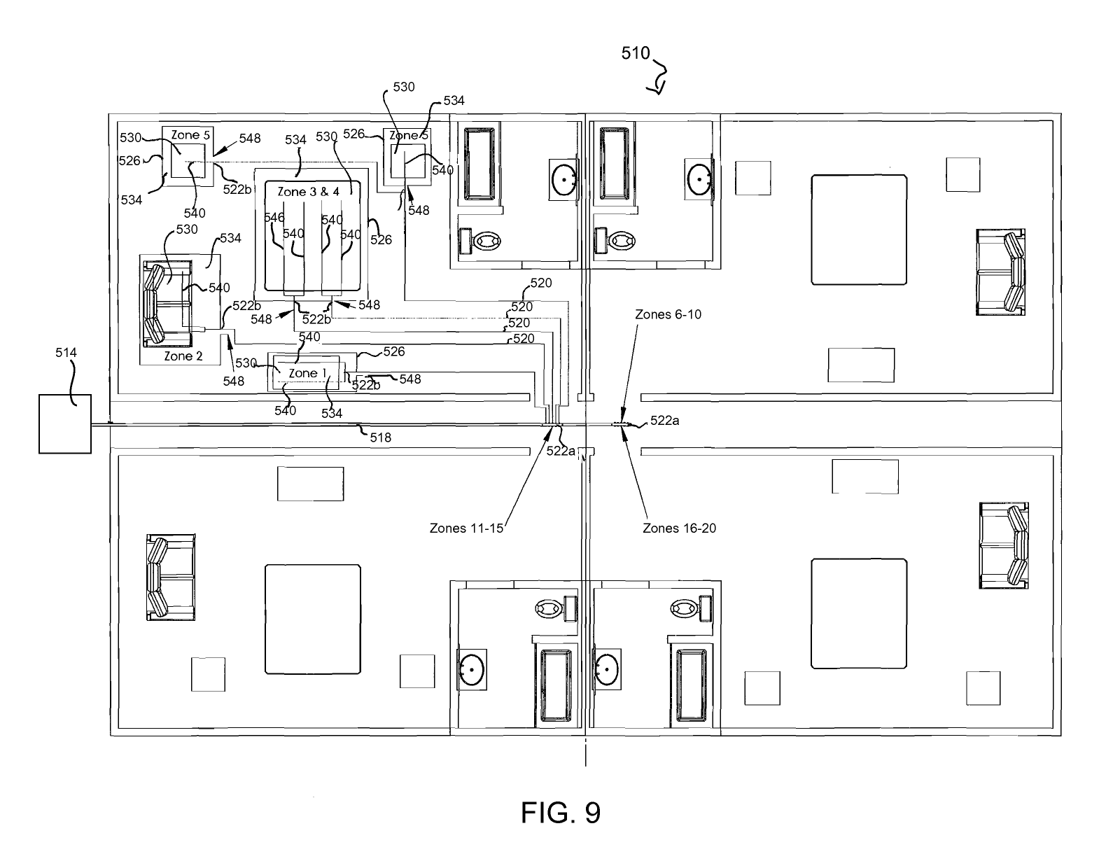

Referring now to FIG. 9, there is shown a perspective view of a multi zone steam injection system, generally indicated at 510. According to principle of the present invention, multiple thermal kill zones 534 can be set up and treated simultaneously. Connected to main injection manifold 522a may be a plurality of primary lines 520. At an opposite end, primary line 520 may be attached to injection manifolds 522b from which barrier lines 526 extend to define each separate thermal kill zone 534. Additionally, injection members 540 may be connected to injection manifolds 522b and inserted into furniture located within thermal kill zones 534, such as a bed, couch, etc. Steam created by steam generator 514 may then be directed into thermal kill zones 534 simultaneously. One of skill in the art will appreciate that by setting up thermal kill zones throughout a house, the entire house may be treated simultaneously.

Once each the areas within thermal kill zones 534 are treated, steam may be manually directed into the joints, cracks or crevices, and into any carpet or other surfaces to ensure that all bed bugs or other insects located within thermal kill zone 534 have been killed. Furthermore, to be sure that all bed bugs and/or other insects are eradicated from the entire house, steam may manually directed into all window seals, outlets, baseboards, molding, curtain hangers, etc., where bed bugs and/or other insects may be found. Finally, to prevent future infestations of bed bugs and/or other insects all cracks or crevices larger than one sixteen of an inch should be filled.

There is thus disclosed an improved system and methods for killing bed bugs and other insects. It will be appreciated that numerous changes may be made to the present invention without departing from the scope of the claims.

What is claimed is:

1. A system for killing insects comprising:
a barrier defining an area;
a steam generator;
wherein the steam created by the steam generator is directed into the area defined by the barrier in order to raise the temperature in the area above the thermal death point of the insects.

2. The system for killing insects according to claim 1, wherein the temperature of the area defined by the barrier is raised above the thermal death point of bed bugs.

3. The system for killing insects according to claim 1, wherein the temperature of the area defined by the barrier is raised to about 115° F. for about seven minutes.

4. The system for killing insects according to claim 1, wherein the temperature of the area defined by the barrier is raised to a range of about 115° F. to about 212° F.

5. The system for killing insects according to claim 1 further comprising at least one injection member.

6. The system for killing insects according to claim 5, wherein the at least one injection member is inserted into a piece of furniture located within the area defined by the barrier.

7. The system for killing insects according to claim 5 further comprising at least one injection manifold.

8. The system for killing insects according to claim 7, wherein the at least one injection manifold is connected to the steam generator and the at least one injection member is connected to the at least one injection manifold.

9. The system for killing insects according to claim 1, further comprising a cover.

10. The system for killing insects according to claim 7, wherein the barrier comprises a conduit connected to the at least one manifold so that steam enters the conduit and increases the temperature of the exterior surface of the barrier to a sufficient degree to prevent insects from crossing the conduit.

11. The system for killing insects according to claim 1 further comprising a plurality of barriers, each of the plurality of barriers defining a separate area.

12. The system for killing insects according to claim 1 further comprising a temperature probe for monitoring a temperature inside the area defined by the barrier.

13. The system for killing insects according to claim 1, wherein the barrier comprises a box with a lid.

14. The system for killing inset according to claim 5, wherein the at least one injection member may be used to manually direct steam into a joint, crack, or crevice.

15. A system for killing bed bugs comprising steam created by a steam generator, wherein the steam is directed into an area for a sufficient amount of time to kill the bed bugs.

16. A method for eradicating bed bugs and/or other insects from a dwelling, the method comprising the steps of:
selecting a steam generator;
creating a thermal kill zone; and
directing steam created by the steam generator into the thermal kill zone to raise the temperature of an area within the thermal kill zone above the thermal death point of bed bugs or other insects.

17. The method of claim 16, wherein the temperature of an area within the thermal kill zone is raised to about 115° F. for about seven minutes.

18. The method of claim 16, wherein the temperature of an area within the thermal kill zone is raised to a range of about 115° F. to about 212° F.

19. The method of claim 16, further comprising the step of connecting at least one injection member to the steam generator.

20. The method of claim 19, further comprising the step of inserting the at least one injection member into a piece of furniture located within the thermal kill zone.
